(19) United States
(12) Patent Application Publication
(10) Pub. No.: US 2010/0316893 A1
(43) Pub. Date: Dec. 16, 2010

(54) SECONDARY BATTERY INCLUDING PROTECTION CIRCUIT MODULE AND METHOD FOR MANUFACTURING THE SAME

(75) Inventor: Woochul KIM, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/790,027

(22) Filed: May 28, 2010

(30) Foreign Application Priority Data
Jun. 15, 2009 (KR) 10-2009-0053016

(51) Int. Cl. H01M 14/00; H01M 10/04

(52) U.S. Cl. 429/7; 29/623.1

(57) ABSTRACT

A secondary battery including a protection circuit module and a method for manufacturing the secondary battery. The secondary battery includes: a bare cell having an electrode assembly; a protection circuit module having a circuit board having a first coupling pad and a first welding pad spaced apart from each other; and at least one electrode tab joined to the first coupling pad of the circuit board by welding and electrically connected to the electrode assembly. The first coupling pad is electrically connected to the first welding pad.

### CROSS-REFERENCE TO RELATED APPLICATIONS

This application claims the benefit of Korean Patent Application No. 10-2009-0053016, filed Jun. 15, 2009, in the Korean Intellectual Property Office, the disclosure of which is incorporated herein by reference.

### BACKGROUND OF THE INVENTION

1. Field of the Invention

Aspects of the present invention relate to a secondary battery. More particularly, an aspect of the present invention relates to a secondary battery including a protection circuit module and a method for manufacturing the secondary battery.

2. Description of the Related Art

Recent rapid advances in the electronics, communications and computer industries have increased the use of portable electronic devices. Most of such portable electronic devices employ rechargeable secondary batteries as power sources.

Secondary batteries are widely used at present in the form of battery packs. A typical secondary battery pack has a bare cell serving as an electrical energy source and a protection circuit module (PCM) to stably control the charging/discharging of the bare cell combined into one unit. Resistance welding is a traditional method for electrically connecting bare cells to the protection circuit modules in secondary batteries. According to a typical resistance welding technique, two welding rods are used to join an electrode tab that is coupled to a bare cell to a circuit board of a protection circuit module. However, the resistance welding technique is carried out in such a manner that the welding rods are brought into contact with predetermined positions of the circuit board where the electrode tab is to be coupled, which inevitably results in poor workability.

### SUMMARY OF THE INVENTION

An aspect of the present invention provides a secondary battery which includes: a bare cell having an electrode assembly; a protection circuit module having a circuit board having a first coupling pad and a first welding pad spaced apart from each other; and at least one electrode tab joined to the first coupling pad of the circuit board by welding and electrically connected to the electrode assembly, wherein the first coupling pad is electrically connected to the first welding pad.

According to another aspect of the present invention, the first coupling pad may be made of the same material as the electrode tab.

According to another aspect of the present invention, the first coupling pad may be formed by plating.

According to another aspect of the present invention, the first coupling pad may be a conductive plate.

According to another aspect of the present invention, the first welding pad may be formed by plating.

According to another aspect of the present invention, the first welding pad may be a conductive plate.

According to another aspect of the present invention, the first coupling pad may be made of gold or nickel.

According to another aspect of the present invention, the first welding pad may be made of gold, copper or nickel.

According to another aspect of the present invention, the first coupling pad may have a thickness of at least 20 μm.

According to another aspect of the present invention, the first coupling pad and the first welding pad may be electrically connected to each other through a first interconnection line formed in the circuit board. The first interconnection line may be integrally formed with an interconnection pattern of the circuit board.

According to another aspect of the present invention, the circuit board may include a first base layer formed under the first coupling pad and a second base layer formed under the first welding pad, the first and second base layers being electrically connected to each other. The first and second base layers may be integrally formed with the interconnection pattern of the circuit board.

According to another aspect of the present invention, the circuit board may include a first surface and a second surface opposite to the first surface; the first coupling pad may be formed on the first surface; and the first welding pad may be formed on the second surface. The first welding pad may be disposed opposite to the first coupling pad on the second surface of the circuit board.

According to another aspect of the present invention, the first coupling pad and the first welding pad may be formed on the same surface of the circuit board.

According to another aspect of the present invention, the circuit board may include a second coupling pad and a second welding pad which are spaced apart from each other and electrically connected to each other. The second coupling pad may be electrically connected to the second welding pad through a second interconnection line formed in the circuit board.

Another aspect of the present invention provides a method for manufacturing a secondary battery, the method including: preparing a bare cell provided with an electrode assembly; preparing a protection circuit module provided with a circuit board having a first coupling pad and a first welding pad, which are electrically connected to each other and spaced apart from each other; and electrically connecting an electrode tab, that is electrically connected to the electrode assembly, to the circuit board by welding, wherein the welding is carried out by resistance welding in response to a first welding rod being brought into contact with the first coupling pad and a second welding rod being brought into contact with the first welding pad.

According to another aspect of the present invention, the first coupling pad and the first welding pad may be formed on opposite surfaces of the circuit board so the two welding rods may be arranged opposite to each other through the circuit board. The first welding rod may be positioned opposite to the second welding rod through the circuit board.

According to another aspect of the present invention, the first coupling pad and the first welding pad may be formed on the same surface of the circuit board to allow the two welding rods to be arranged on the same surface of the circuit board.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a secondary battery including a protection circuit module according to an embodiment of the present invention;

FIG. 2 is a front view illustrating the secondary battery of FIG. 1;

FIG. 3 is a partial cross-sectional view illustrating the circuit board of the secondary battery of FIG. 2;

FIG. 4 is a flow chart illustrating a method for manufacturing the secondary battery of FIG. 1;

FIG. 5 is a process view illustrating the welding operation of the method of FIG. 4; and

FIG. 6 is a side view illustrating a protection circuit module of a secondary battery according to another embodiment of the present invention and a state in which an electrode tab is welded to the protection circuit module.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

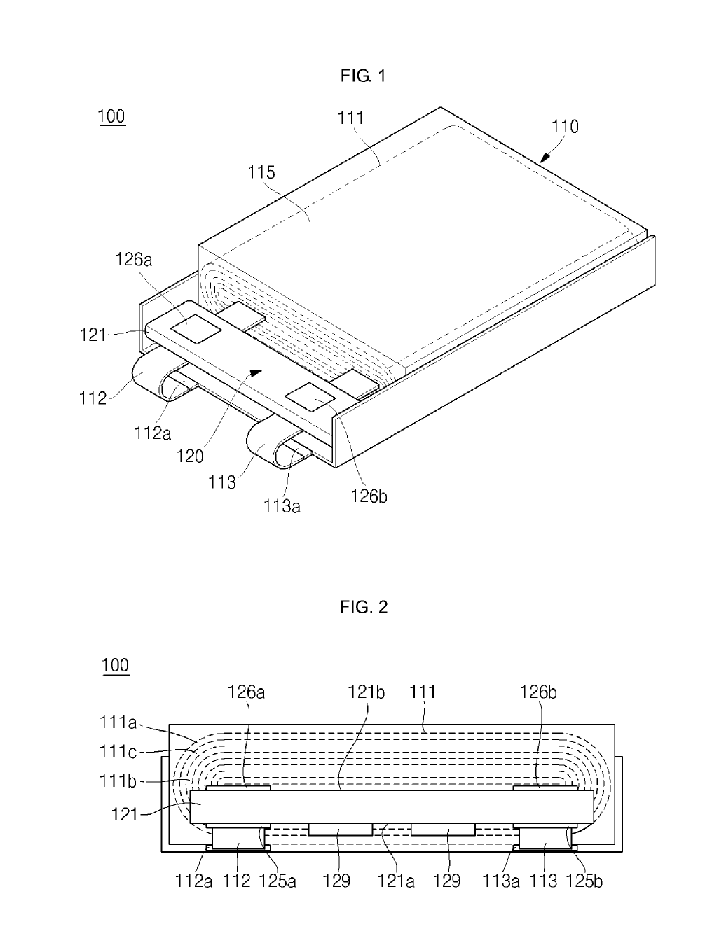

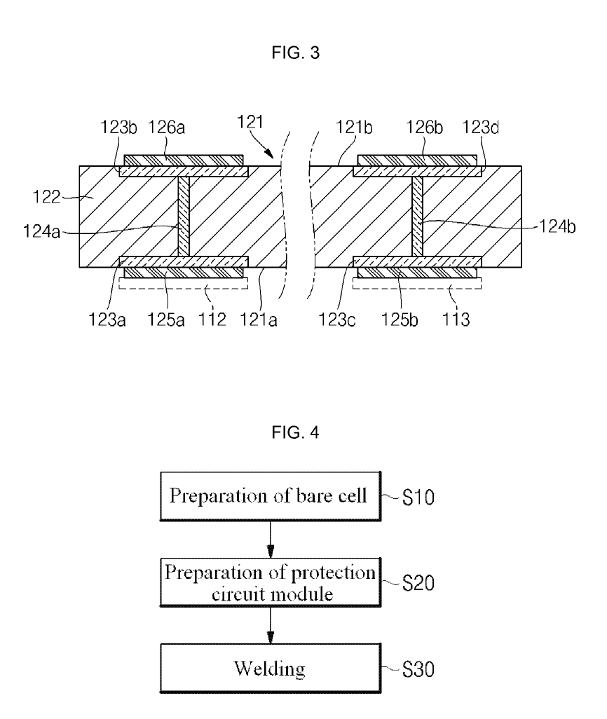

FIG. 1 is a perspective view of a secondary battery including a protection circuit module according to an embodiment of the present invention, FIG. 2 is a front view illustrating the secondary battery of FIG. 1, and FIG. 3 is a partial cross-sectional view illustrating the circuit board of the secondary battery of FIG. 2.

Referring to FIGS. 1 through 3, the secondary battery 100 includes a bare cell 110 and a protection circuit module (PCM) 120.

The bare cell 110 serves as an electrical energy source. The bare cell 110 includes an electrode assembly 111 and an outer case 115 accommodating the electrode assembly 111 therein.

The electrode assembly 111 is constructed by winding a laminate of a first electrode plate 111a, a second electrode plate 111b and a separator 111c interposed between the two electrode plates 111a and 111b. In this embodiment, the first and second electrode plates 111a and 111b function as positive and negative electrode plates, respectively. It will be appreciated by those skilled in the art that the first and second electrode plates 111a and 111b can function as negative and positive electrode plates, respectively.

Although not shown in detail, the first electrode plate 111a, acting as a positive electrode plate, includes a positive electrode collector and a positive electrode active material layer attached to the positive electrode collector. The positive electrode collector is generally made of aluminum. The positive electrode collector provides a path through which charges flow from the positive electrode active material layer. The positive electrode collector plays a role in supporting the positive electrode active material layer. The first electrode plate 111a has a positive electrode non-coating portion that is not covered by the positive electrode active material layer at one side end thereof. A first electrode tab 112 made of nickel is connected to the positive electrode non-coating portion and extends outward from the outer case 115. A first insulating tape 112a is attached to a middle portion of the first electrode tab 112 to insulate the first electrode tab 112 from the outer case 115. The positive electrode active material layer is composed of a lithium-containing layered compound as an active material, a binder to improve the bonding strength between the active material particles, and a conductive material to improve the conductivity of the active material.

Although not shown in detail, the second electrode plate 111b, acting as a negative electrode plate, includes a negative electrode collector and a negative electrode active material layer attached to the negative electrode collector. The negative electrode collector is generally made of copper. The negative electrode collector provides a path through which charges flow from the negative electrode active material layer. The negative electrode collector plays a role in supporting the negative electrode active material layer. The second electrode plate 111b has a negative electrode non-coating portion that is not covered by the negative electrode active material layer at one side end thereof. A second electrode tab 113 made of nickel is connected to the negative electrode non-coating portion and extends outward from the outer case 115. A second insulating tape 113a is attached to a middle portion of the second electrode tab 113 to insulate the second electrode tab 113 from the outer case 115. The negative electrode active material layer is composed of a carbon-based material as an active material and a binder to improve the bonding strength between the active material particles. Hard carbon is mainly used as the carbon-based material. Graphite may also be used as the carbon-based material, however aspects of the present invention are not limited thereto.

The separator 111c is interposed between the first electrode plate 111a and the second electrode plate 111b to insulate the two electrode plates 111a and 111b. The charges pass from the first and second electrode plates 111a and 111b through the separator 111c. The separator 111c may be made of any suitable material known in the art. Generally, the separator 111c is made of polyethylene (PE) or polypropylene (PP), however aspects of the present invention are not limited thereto.

The outer case 115 is in the form of a pouch. Although not shown in detail, the outer case 115 has an opening, a hollow body accommodating the electrode assembly 111 therein, and a cover closing the opening to seal the body. The first electrode tab 112 and the second electrode tab 113 of the electrode assembly 111 protrude outward and extend from the outer case 115.

The protection circuit module 120 includes a circuit board 121 and electrical circuit devices 129 mounted on the circuit board 121. The protection circuit module 120 controls various operations (including charge/discharge operation) of the secondary battery 100.

The circuit board 121 is a printed circuit board having an interconnection pattern printed thereon. The circuit board 121 has an insulating layer 122, first, second, third and fourth base layers 123a, 123b, 123c and 123d, first and second interconnection lines 124a and 124b, first and second coupling pads 125a and 125b, and first and second welding pads 126a and 126b. The base layers 123a, 123b, 123c and 123d, the coupling pads 125a and 125b, and the welding pads 126a and 126b are electrically conductive. The circuit board 121 has a first surface 121a and a second surface 121b opposite to the first surface 121a.

The insulating layer 122 may be formed of any suitable material known in the art. The insulating layer 122 is generally formed of paper or a phenolic resin, however aspects of the present invention are not limited thereto. The base layer 123a is formed at the first surface 121a of the circuit board 121. The second base layer 123b is formed at the second surface 121b of the circuit board 121 and is disposed opposite to the first base layer 123a. The third base layer 123c is formed at the first surface 121a of the circuit board 121. The fourth base layer 123d is formed at the second surface 121b of the circuit board 121 and is disposed opposite to the third base layer 123c. The first, second, third and fourth base layers 123a, 123b, 123c and 123d are formed of conductors, such as copper foils, however aspects of the present invention are not limited thereto. The base layers 123a, 123b, 123c and 123d may be formed simultaneously when the interconnection pattern of the circuit board 121 is formed or may be formed in a separate operation after the formation of the interconnection pattern.

The first interconnection line 124a and the second interconnection line 124b are formed simultaneously when the interconnection pattern of the circuit board 121 is formed. The first interconnection line 124a electrically connects the first base layer 123a to the second base layer 123b. The second interconnection line 124b electrically connects the third base layer 123c and the fourth base layer 123d.

The first coupling pad 125a is formed on the first base layer 123a. The first coupling pad 125a may be formed by plating an electrically conductive material on the first base layer 123a. Alternatively, the first coupling pad 125a may be formed by attaching a plate made of an electrically conductive material to the first base layer 123a. The first coupling pad 125a is made of the same material as the first electrode tab 112 to facilitate resistance welding of the first coupling pad 125a to the first electrode tab 112. In this embodiment, the first coupling pad 125a is formed by gold or nickel plating, however aspects of the present invention are not limited thereto. The first electrode tab 112 is joined to the first coupling pad 125a by resistance welding. The first coupling pad 125a has a thickness of at least 20 μm, which allows the resistance welding to be satisfactorily performed. If the first coupling pad 125a is thinner than 20 μm, the resistance welding is not normally done. The second coupling pad 125b is formed on the third base layer 123c. The second coupling pad 125b is structurally and functionally identical to the first coupling pad 125a, and thus a detailed description thereof is omitted. The second electrode tab 113 is joined to the second coupling pad 125b by resistance welding.

The first welding pad 126a is formed on the second base layer 123b. The first welding pad 126a may be formed by plating an electrically conductive material on the second base layer 123b. Alternatively, the first welding pad 126a may be formed by attaching a plate made of an electrically conductive material to the second base layer 123b. The first welding pad 126a may be made of any suitable plating material known in the art. In this embodiment, the first welding pad 126a is formed by gold, copper or nickel plating, however aspects of the present invention are not limited thereto. A welding rod to perform resistance welding is brought into contact with the first welding pad 126a. For ease of the welding, the position of the first welding pad 126a can be suitably determined by taking into consideration various factors, such as the mounting positions of the electrical circuit devices 129 and working environment. The second welding pad 126b is formed on the fourth base layer 123d. The second welding pad 126b is structurally and functionally identical to the first welding pad 126a, and thus a detailed description thereof is omitted. Another welding rod to perform resistance welding is brought into contact with the second welding pad 126b.

The electrical circuit devices 129 are mounted on the first surface 121a of the circuit board 121. The electrical circuit devices 129 include a control IC, a charge/discharge switch, a thermal fuse, such as a positive temperature coefficient (PTC) thermistor, or other similar electric circuit devices.

FIG. 4 is a flow chart illustrating a method for manufacturing the secondary battery of FIG. 1.

Referring to FIG. 4, the method includes the following operations: preparation of a bare cell S10; preparation of a protection circuit module S20; and welding S30.

In operation S10, a bare cell 110 is prepared. The bare cell 110 has the same structure and functions of the bare cell explained previously with reference to FIGS. 1 and 2.

In operation S20, a protection circuit module 120 is prepared. The protection circuit module 120 has the same structure and functions of the protection circuit module explained previously with reference to FIGS. 1 through 3.

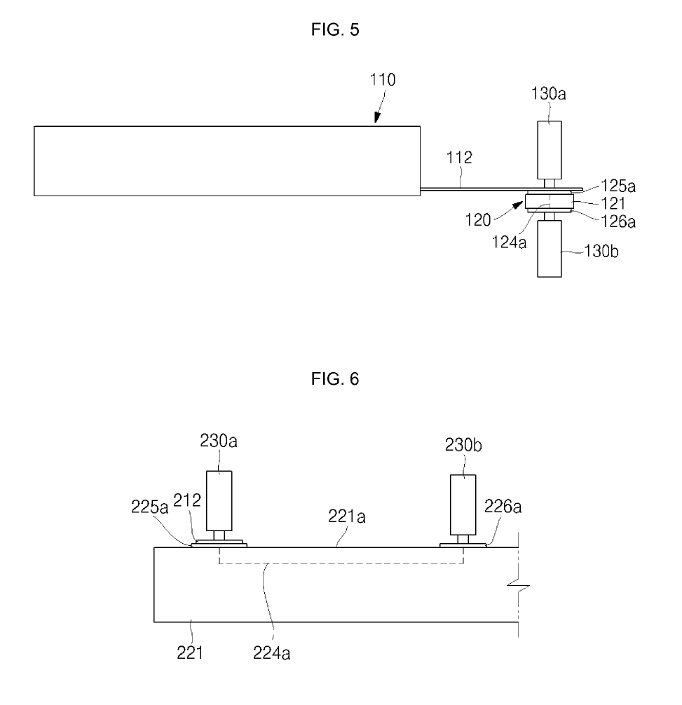

In operation S30, the bare cell 110 is electrically connected to the protection circuit module 120 by resistance welding. The welding operation is illustrated in FIG. 5. Referring to FIG. 5, the first electrode tab 112 of the bare cell 110 is placed on the first coupling pad 125a formed on the circuit board 121 of the protection circuit module 120. In this state, a first welding rod 130a is brought into contact with the first electrode tab 112 of the bare cell 110 and a second welding rod 130b is brought into contact with the first welding pad 126a formed on the circuit board 121. When a voltage is applied between the two welding rods 130a and 130b, an electric current flows between the two welding rods 130a and 130b through the interconnection line 124a, which electrically connects the first coupling pad 125a to the first welding pad 126a. As a result of the resistance welding, the first electrode tab 112 of the bare cell 110 is joined to the first coupling pad 125a. Thereafter, the second electrode tab 113 is joined to the second coupling pad 125b by resistance welding in the same manner as described above.

FIG. 6 illustrates a protection circuit module of a secondary battery according to another embodiment of the present invention. Referring to FIG. 6, a first coupling pad 225a, to which an electrode tab 212 is coupled, and a first welding pad 226a are formed on one surface 221a of a circuit board 221. The first coupling pad 225a and the first welding pad 226a are electrically connected to each other through a first interconnection line 224a. In a state in which two welding rods 230a and 230b are positioned on the electrode tab 212 and the first welding pad 226a, respectively, the electrode tab 212 is joined to the first coupling pad 225a by resistance welding. That is, the two welding rods 230a and 230b are positioned on the same surface 221a of the circuit board 221. For ease of the welding, the position of the first welding pad 226a can be suitably determined taking into consideration various factors, such as a working environment. The other elements of the circuit board 221 are the same as those of the circuit board 121 illustrated in FIGS. 1 through 3, and thus a detailed description thereof is omitted.

The secondary batteries of these embodiments have been explained as being of pouch type in which the outer case of the bare cell is in the form of a pouch, but the type of the secondary batteries, according to aspects of the present invention, are not limited to the thereto. It will be understood by those skilled in the art that the same explanation of the secondary batteries having the outer case in the form of a pouch can be applied to a secondary battery having an outer case in the form of a can, or other similar outer cases.

As is apparent from the above description, the welding pad in contact with one of the two welding rods can be freely positioned, thus achieving markedly improved workability of resistance welding for electrically connecting the bare cell to the protection circuit module.

In addition, the two welding rods to perform resistance welding can be positioned opposite to each other through the circuit board, thus saving space to perform the welding.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A secondary battery comprising
a bare cell having an electrode assembly;
a protection circuit module having a circuit board having a first coupling pad and a first welding pad spaced apart from each other; and
at least one electrode tab joined to the first coupling pad of the circuit board by welding and electrically connected to the electrode assembly,
wherein the first coupling pad is electrically connected to the first welding pad.

2. The secondary battery of claim 1, wherein the first coupling pad is made of the same material as the electrode tab.

3. The secondary battery of claim 1, wherein the first coupling pad is formed by conductive plating.

4. The secondary battery of claim 1, wherein the first welding pad is formed by conductive plating.

5. The secondary battery of claim 1, wherein the first coupling pad is made of gold or nickel.

6. The secondary battery of claim 1, wherein the first welding pad is made of gold, copper or nickel.

7. The secondary battery of claim 1, wherein the first coupling pad and the first welding pad are electrically connected to each other through a first interconnection line formed in the circuit board.

8. The secondary battery of claim 7, wherein the first interconnection line is integrally formed with an interconnection pattern of the circuit board.

9. The secondary battery of claim 8, wherein the circuit board comprises:
a first base layer formed under the first coupling pad; and
a second base layer formed under the first welding pad,
wherein the first and second base layers are electrically connected to each other.

10. The secondary battery of claim 9, wherein the first and second base layers are integrally formed with the interconnection pattern of the circuit board.

11. The secondary battery of claim 1, wherein the circuit board comprises:
a first surface; and
a second surface opposite to the first surface,
wherein the first coupling pad is formed on the first surface and the first welding pad is formed on the second surface.

12. The secondary battery of claim 11, wherein the first welding pad is disposed opposite to the first coupling pad on the second surface of the circuit board.

13. The secondary battery of claim 1, wherein the first coupling pad and the first welding pad are formed on the same surface of the circuit board.

14. The secondary battery of claim 1, wherein the circuit board further comprises:
a second coupling pad; and
a second welding pad,
wherein the second coupling pad and the second welding pad are spaced apart from each other and electrically connected to each other.

15. The secondary battery of claim 14, wherein the second coupling pad is electrically connected to the second welding pad through a second interconnection line formed in the circuit board.

16. A method for manufacturing a secondary battery, the method comprising
preparing a bare cell provided with an electrode assembly;
preparing a protection circuit module provided with a circuit board having a first coupling pad and a first welding pad, which are electrically connected to each other and spaced apart from each other; and
electrically connecting an electrode tab, that is electrically connected to the electrode assembly, to the circuit board by welding,
wherein the welding is carried out by resistance welding in response to a first welding rod being brought into contact with the first coupling pad and a second welding rod being brought into contact with the first welding pad.

17. The method of claim 16, wherein the first coupling pad and the first welding pad are formed on opposite surfaces of the circuit board to allow the two welding rods to be arranged opposite to each other through the circuit board.

18. The method of claim 17, wherein the first welding rod is positioned opposite to the second welding rod through the circuit board.

19. The method of claim 16, wherein the first coupling pad and the first welding pad are formed on the same surface of the circuit board to allow the two welding rods to be arranged on the same surface of the circuit board.
